(19) United States
(12) Patent Application Publication
(10) Pub. No.: US 2006/0227572 A1
(43) Pub. Date: Oct. 12, 2006

(54) DISTORTION-RESISTANT BACKLIGHT MODULE

(76) Inventor: Ga-Lane Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,386

(22) Filed: Mar. 20, 2006

(30) Foreign Application Priority Data
Apr. 8, 2005 (TW) 094111155

(51) Int. Cl. F21V 7/04

(52) U.S. Cl. 362/633

(57) ABSTRACT

The present invention relates to a distortion-resistant backlight module. The distortion-resistant backlight includes a light guide plate, a light source, a light cover and a retention frame. The light source is used to supply incident light beams for the light guide plate. The light cover is configured surrounding the light source. The retention frame is used to retain the light guide plate and the retention frame is made of a shape memory material for prevent the light guide plate from distorting.

### FIELD OF THE INVENTION

The present invention relates to backlight modules, and more particularly to a distortion-resistant backlight module for use in, for example, a liquid crystal display.

### DESCRIPTION OF RELATED ART

Liquid crystal materials can not intrinsically emit light, rather, a liquid crystal display must be equipped with an external light source. The so-called external light source is namely a backlight system or a front light system, which is used in conjunction with the liquid crystal display. A typical backlight or front light system includes a light guide plate for converting a point light source or a linear light source into a planar light source.

A conventional backlight module includes a light guide plate, a light source attached to at least one edge of the light guide plate, and a reflecting sheet disposed at a bottom surface of the light guide plate. In addition, the backlight module employing the light guide plate also employs a number of additional complementary elements such as fixture frames for fixing the light guide plate, diffusers, prism sheets and so on.

However, the light guide plate fixture frames in a conventional backlight module can be very unreliable. As temperature and humidity changes, joints between the fixture frames and light guide plate may become loose. As a result, the light guide plate may be deformed and cause deflection. Thus, a uniformity and brightness of the emitting light beams from the deflective light guide plate will be affected seriously. In addition, as acted upon by an external force, the fixture frame may be distorted, the resulting pressure may destroy the light guide plate, and light beam quality will be affected accordingly.

To prevent humidity absorption from causing loose joints between the fixture frames and light guide plate, people skilled in the art usually attach water-resistant protective films on surfaces of the light guide plate to isolate the light guide plate from moisture in the air, thereby the looseness between the fixture frames and the light guide plate may be avoided. However, the light reaching the liquid crystal may be decreased greatly because of the addition of this piece of protective film, thus the brightness of the liquid crystal display will be lowered.

In order to solve temperature differentials problems, people skilled in the art usually add a heat transmission element to lower the temperature of the light guide plate, through this the distortion of the light guide plate may be reduced, and the looseness of the joints between the fixture frames and light guide plate can be reduced correspondingly. However, the added heat transmission element can prevent the distortion of the light guide plate to some extent, but this also results in high manufacturing costs and unduly complicated assembly procedures.

It is desired to provide an improved distortion-resistant backlight module that overcomes the above-described problems.

### SUMMARY OF INVENTION

An embodiment of a distortion-resistant backlight module includes a light guide plate, a light source, a light cover and a retention frame. The light source is used to supply incident light beams for the light guide plate. The light cover is configured surrounding the light source. The retention frame is used to retain the light guide plate. The retention frame is made from a shape memory material.

Advantages and novel features of the present distortion-resistant backlight module will become more apparent from the following detailed description of preferred embodiments when taken in conjunction with the accompanying drawings.

### BRIEF DESCRIPTION OF DRAWINGS

Many aspects of the present backlight module can be better understood with reference to the following drawing. The components in the drawing are not necessarily to scale, the emphasis instead being placed upon clearly illustrating the principles of the present backlight module. Moreover, in the drawing, like reference numerals designate corresponding parts throughout the several views.

FIG. 1 is a schematic, isometric explosive view of a distortion-resistant backlight module having a light guide plate in accordance with a first embodiment;

FIG. 2 is an enlarged view of a circled portion of the light guide plate of FIG. 1; and

FIG. 3 is a schematic, isometric view of an alternative retention frame.

### DETAILED DESCRIPTION

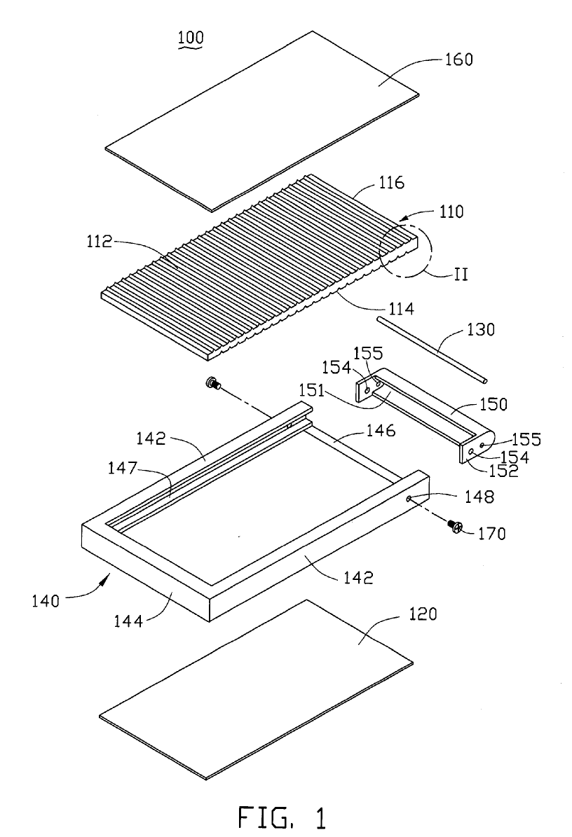

FIG. 1 shows a distortion-resistant backlight module 100 in accordance with a first embodiment. The distortion-resistant backlight module 100 includes a light guide plate 110, a reflecting plate 120, a light source 130, a light cover 150, a diffusing plate 160 and a retention frame 140. The light cover 150 is disposed to surround the light source 130. The retention frame 140 is used to retain the light guide plate 110.

The light guide plate 110 may be a wedge-shaped block or flat sheet having a uniform thickness. In this embodiment, the light guide plate 110 is a wedge-shaped block. The light guide plate 110 has an incident surface 116 located at a thick end thereof for receiving light beams from the light source 130, two side surfaces extending from the thick end to a thin end of the block, an emitting surface 112 adjoining the incident surface 116 and the side surfaces, and a bottom surface 114 opposite to the emitting surface 112.

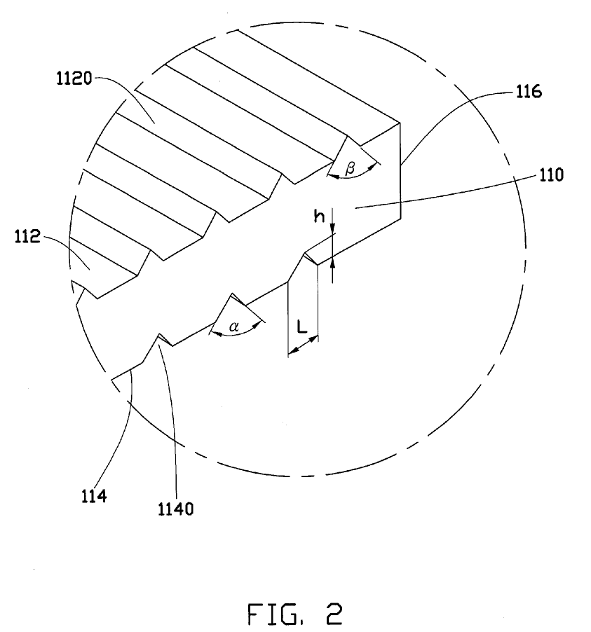

Referring to FIG. 2, an array of grooves 1140, for example V-shaped grooves, is defined in the bottom surface 114. The V-shaped grooves 1140 all have substantially similar depth, length and α-angle. An array of protrusions 1120, for example V-shaped protrusions, is formed on the emitting surface 112. The V-shaped protrusions 1120 all have a same height, length and β-angle. Density of the grooves and the protrusions is uniform along a direction from the thick end to the thin end of the light guide plate 110. Preferably, the array of the V-shaped grooves is configured spatially corresponding to the protrusions. In order words, the V-shaped grooves are preferably vertically aligned with the corresponding V-shaped protrusions The V-shaped grooves 1140 and the V-shaped protrusions 1120 may be configured to be contiguous or discrete from each other respectively.

Depth of the each of the grooves 1140 is in the range from 1 micrometer to 20 micrometers. Length of each of the grooves 1140 is in the range from 10 micrometers to 200 micrometers. α-angle of the each of the grooves 1140 is in the range from 130 degrees to 160 degrees. Height of each of the protrusions 1120 is in the range from 1 micrometer to 20 micrometers. Length of each of the protrusions 1120 is in the range from 10 micrometers to 200 micrometers. β-angle of each of the protrusions 1120 is in the range from 80 degrees to 130 degrees.

The grooves and protrusions may also be U-shaped, dot patterned and so on in structure. For example, the V-shaped grooves 1140 can be replaced by dot patterns, and dot patterns density in the bottom surface 114 would gradually increase from the thick end of the light guide plate 110 to the thin end. The V-shaped protrusions 1120 are replaced by U-shaped protrusions, and the U-shaped protrusions can be configured to be discrete on the emitting surface 112.

Referring to FIG. 1, the light cover 150 includes a reflecting surface 151 facing towards the light incident surface 116. Two opposite supporting portions 152 may be formed extending from the reflecting surface 151 along a direction towards the light incident surface 116. Two screw holes 155 are defined separately in the two supporting portions 152 for fixing the light source 130 inside the light cover 150. Two first screw holes 154 may be defined in each of the two supporting portions 152 for assembling the light cover 150 and the retention frame 140.

The retention frame 140 includes two opposite positioning sidewalls 142, a first connecting part 144 and an opposite second connecting part 146. Two ends of the first connecting part 144 are separately connected with one same end of the two opposite positioning sidewalls 142, and two ends of the second connecting part 146 are separately connected with another same end of the two opposite positioning sidewalls 142. A volume defined by the two opposite positioning sidewalls 142, the first connecting part 144 and the second connecting part 146 may be smaller than a dimension of the light guide plate 110, thus the light guide plate 110 can be interferingly inlaid in the retention frame 140. The second connecting part 146 is employed to support the light guide plate 110 inside the retention frame 140.

A retaining slot 147 is defined in each of the positioning sidewalls 142 for the light guide plate 110 being engaged in the retention frame 140. The retaining slots 147 gradually narrower in width towards an end, and the width can be configured corresponding to that of the light guide plate 110. That is, each of the retaining slots 147 has a wide end and a narrow end. The wide end of the retaining slots 147 is configured corresponding to the thick end of the light guide plate 110. The narrow end of the retaining slots 147 is configured corresponding to the thin end of the light guide plate 110. A pair of second screw holes 148 may be defined in one end of the two positioning sidewalls 142. The light cover 150 can be assembled with the retention frame 140 by a pair of screws 170 extending through the two first screw holes 154 and two second screw holes 148 separately.

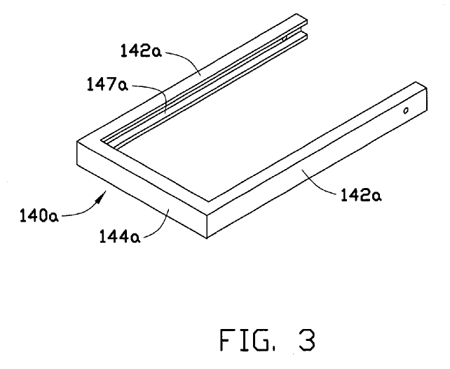

FIG. 3 shows an alternative retention frame 140a. The retention frame 140a includes two opposite positioning sidewalls 142a and a first connecting part 144a. Two ends of the first connecting part 144a are separately connected with one same end of the two positioning sidewalls 142a. Three retaining slots 147a are defined in the two positioning sidewalls 142a and the first connecting part 144a, or the retaining slots 147a can be solely defined in the two positioning sidewalls 142a with no slot defined in the first connecting part 144a.

Furthermore, the light guide plate 110 may be arranged inside the retention frame 140 by other means, for example, the light guide plate 110 can be connected with the retention frame 140 by agglutinating method such as that using an adhesive.

The retention frame 140 may be made of shape memory materials. The shape memory material has a shape memory effect (Shape Memory Effect, SME). A definition of the shape memory effect is that under certain conditions a structure made of shape memory materials can return to its previous structure after being changed by an outside force. The shape memory material may be a shape memory alloy (Shape Memory Alloy, SMA). Shape memory alloy is generally composed of two or more metal elements. Once shape memory alloy acted upon by an external force, a metal atom will leave its original place to another place. Under appropriate conditions, for example, at an appropriate temperature, the metal atom can be made to return to its original place, as a result, the structure of the shape memory alloy will return also. The appropriate temperature at which the shape memory alloy returns to its structure can be called its transition temperature.

The shape memory material of the retention frame 140 may be a copper (Cu) alloy or a nickel-titanium (Ni—Ti) alloy. The copper alloy is selected from the group consisting of a Cu—Al—Ni alloy, a Cu—Al—Fe alloy, a Cu—Ni—Ti alloy, a Cu—Zr—Zn alloy, a Cu—Al—Zn alloy, a Cu—Al—Fe—Zn alloy and so on (where Al is aluminum, Fe is iron, Zr is zirconium, Zn is zinc). The nickel-titanium alloy is selected from the group consisting of a Ni—Ti—Al—Cu alloy, a Ni—Ti—Al—Zn alloy, a Ni—Ti—Al—Zn—Cu alloy and so on.

In assembling the distortion-resistant backlight module 100, first of all, the light guide plate 110 can be pushed into the retention frame 140 along the two retaining slots 147, so that the light guide plate 110 can be inlaid the retention frame 140. Then the light cover 150 is assembled on the retention frame 140 by the two screws 170. In order that the light guide plate 110 will not be loosed during the assembling process, preferably, the light guide plate 110 can be agglutinated with the retention frame 140 by an adhesive before assembling the light cover 150, then the light cover 150 is assembled on the retention frame 140 by the two screws 170. Thus, a desired distortion-resistant backlight module 100 is obtained.

Because of the retention frame 140 is made from shape memory materials, the retention frame 140 can adapt to outside environmental changes such as temperature and humidity changes. The retention frame 140 does this by offsetting the looseness of the joints between the light guide plate 110 and the retention frame 140 when outside environmental conditions return or the transition temperature of the shape memory materials is reached. For example, the retention frame 140 is made from a shape memory alloy with a transition temperature being room temperature, during the process of working, the light guide plate 110 can be heated to a high temperature for converting light beams, so the light guide plate 110 may expand through being heated. Then the retention frame 140 will be distorted through being pressed by the light guide plate 110, so the joints between the retention frame 140 and the light guide plate 110 will temporarily loosen. However when the temperature drops back to room temperature, the retention frame 140 will return to its original shape and the looseness will accordingly be eliminated. Thus the deflection of the light guide plate 110 can be avoided.

Furthermore, when the distortion-resistant backlight module 100 is acted on by an outside force, for example, the retention frame 140 is pressed by an outside force, then the structures of the retention frame 140 will temporarily experience elastic deformation, but once the external force is removed, the retention frame 140 can return to its original shape. So damage to the light guide plate 110 caused by the deformation of the retention frame 140 can be greatly minimized.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A distortion-resistant backlight module comprising a light guide plate; a light source for supplying incident light beams for the light guide plate a light cover surrounding the light source; and a retention frame for retaining the light guide plate, the retention frame being made of a shape memory material.

2. The distortion-resistant backlight module as described in claim 1, wherein the shape memory material is comprised of a shape memory alloy.

3. The distortion-resistant backlight module as described in claim 2, wherein the shape memory alloy is selected from one of a copper alloy and a nickel-titanium alloy.

4. The distortion-resistant backlight module as described in claim 3, wherein the copper alloy is selected from the group consisting of a Cu—Al—Ni alloy, a Cu—Al—Fe alloy, a Cu—Ni—Ti alloy, a Cu—Zr—Zn alloy, a Cu—Al—Zn alloy and a Cu—Al—Fe—Zn alloy.

5. The distortion-resistant backlight module as described in claim 3, wherein the nickel-titanium alloy is selected from the group consisting of a Ni—Ti—Al—Cu alloy, a Ni—Ti—Al—Zn alloy and a Ni—Ti—Al—Zn—Cu alloy.

6. The distortion-resistant backlight module as described in claim 1, wherein the retention frame comprises two opposite sidewalls configured to retain the light guide plate.

7. The distortion-resistant backlight module as described in claim 6, wherein the sidewalls define two retaining slots with opposite ends of the light guide plate being engaged therein.

8. The distortion-resistant backlight module as described in claim 6, wherein the light cover comprises two opposite supporting portions coupled to the sidewalls of the retention frame.

9. The distortion-resistant backlight module as described in claim 1, wherein the light guide plate comprises a plurality of V-shaped grooves defined in a bottom surface thereof.

10. The distortion-resistant backlight module as described in claim 9, wherein the light guide plate comprises a plurality of V-shaped protrusions configured on the emitting surface thereof.

11. The distortion-resistant backlight module as described in claim 10, wherein a depth of each of the V-shaped grooves is in the range from 1 to 20 micrometres, a length of each of the V-shaped grooves is in the range from 10 to 200 micrometres, an angle of each of the V-shaped grooves is in the range from 130 to 160 degrees.

12. The distortion-resistant backlight module as described in claim 10, wherein a height of each of the V-shaped protrusions is in the range from 1 to 20 micrometres, a length of each of the V-shaped protrusions is in the range from 10 to 200 micrometres, an angle of each of the V-shaped protrusions is in the range from 80 to 130 degrees.

13. The distortion-resistant backlight module as described in claim 10, wherein the V-shaped grooves are configured spatially corresponding to the V-shaped protrusions.

14. The distortion-resistant backlight module as described in claim 10, wherein the V-shaped grooves are configured to be contiguous or discrete from each other.

15. The distortion-resistant backlight module as described in claim 10, wherein the V-shaped protrusions are configured to be contiguous or discrete from each other.
